(19) United States
(12) Patent Application Publication
(10) Pub. No.: US 2024/0406011 A1
(43) Pub. Date: Dec. 5, 2024

(54) SECURITY ASSURANCE FRAMEWORK FOR TESTING AND VALIDATING CERTIFICATES

(71) Applicant: ARRIS Enterprises LLC, Horsham, PA (US)

(72) Inventors: Xin QIU, San Diego, CA (US); Jinsong ZHENG, San Diego, CA (US); Jason PASION, San Diego, CA (US); Oscar JIANG, West Covina, CA (US); Ole LARSEN, Solana Beach, CA (US); Ting YAO, San Diego, CA (US)

(73) Assignee: ARRIS Enterprises LLC, Horsham, PA (US)

(21) Appl. No.: 18/674,670

(22) Filed: May 24, 2024

Related U.S. Application Data
(60) Provisional application No. 63/470,430, filed on Jun. 1, 2023.

(51) Int. Cl. H04L 9/32

(52) U.S. Cl. CPC H04L 9/3268; H04L 9/3265

(57) ABSTRACT

A method and apparatus for analyzing disparate certificates possibly issued by disparate sources within a disaggregated public key infrastructure is disclosed. In one embodiment, the system comprises a database having a certificate repository and a certificate ingestion interface module, communicatively coupled to the certificate repository, the certificate ingestion interface module for ingesting certificates issued by the disparate sources. The system further comprises an analytics engine, communicatively coupled to the certificate repository, for analyzing attributes of the ingested certificates, a reporting engine, communicatively coupled to the certificate repository, for visualizing and reporting results of the analytics engine via a reporting interface, and an administrative interface, communicatively coupled to the certificate repository, for managing the system.

### CROSS-REFERENCE TO RELATED APPLICATIONS

This application claims benefit of U.S. Provisional Patent Application No. 63/470,430, entitled “SECURITY ASSURANCE FRAMEWORK (SAF) FOR TESTING AND VALIDATING CERTIFICATES,” by Xin Qiu, Jinsong Zheng, Jason Pasion, Oscar Jiang, Ole Larsen, Ting Yao, filed Jun. 1, 2023, which application is hereby incorporated by reference herein.

### BACKGROUND

### 1. Field

The present disclosure relates to systems and methods for authenticating devices.

### 2. Description of the Related Art

Mobile network operators provide cell services with a vast deployment of antennas and radios on cell towers connected to base station equipment. The base station equipment converts the wireless signals to data consisting of text messages, phone calls, streaming videos, and the like. The radios, cell towers, and base station equipment converting wireless signals to data is referred to as a Radio Access Network (RAN).

RANs are traditionally vendor-locked, vertically integrated telecommunications architectures that enable wireless communications, such as 4G, 5G, and subsequent generations of communications technologies. RANs are implemented by a plurality of remote devices (such as mobile phones, laptops, or any remotely controlled machine) communicatively coupled to a core network via a wireless link. The RAN infrastructure is the final link between the network and the mobile device, and is made up of base stations, antennas, and radio units such as smartphones.

By disaggregating RAN architectures—thus making them “Open”—more entities can pursue innovation on advanced 5G network architectures and related security. Open RAN architectures encompass two distinct dimensions “decomposition” that enables “modularity” and disaggregation that enables cloudification and virtualization. The goal of this architecture design is to lower barriers to entry, and, therefore, promote increased competition, vendor diversity, and innovation.

One of the key goals driving the deployment of Open RAN is the creation of a robust multi-vendor ecosystem that drives competition and innovation. The establishment of a multi-vendor Open RAN ecosystem not only creates opportunities for new businesses, both small and large, to enter the previously closed market, but it also limits vendor “lock-in” that can occur under the traditional RAN environment in which the proprietary hardware and software are provided by a single vendor.

Open RAN also builds on the security enhancements of 5G, extending the security benefits offered by virtualization from the core to the edge of the network. Open RAN also provides increased transparency into the RAN, allowing operators to see all aspects of the network and diagnose, remedy, and prevent problems in real time.

The deployment of Open RAN introduces new security considerations for mobile network operators (MNO). By nature, an open ecosystem that involves a disaggregated multi-vendor environment requires specific focus on changes to the threat surface area at the interfaces between technologies integrated via the architecture. In addition to addressing security considerations related to integrating components from multiple vendors, network operators (including service providers) continue to deal with other considerations related to use of open source applications and new 5G network functions and interfaces whose standards are still under development. Additionally, MNOs will need to address security considerations related, but not unique to Open RAN, such as cloud infrastructure, virtualization, containerization, and Distributed Denial of Service attacks.

Open RAN may use certificate-based authentication in a Public Key Infrastructure (PKI) setting to address some of such security issues. Public Key Infrastructure (PKI) is an infrastructure setting forth protocols for public key encryption. Digital certificates are important component of a PKI system, because the digital certificates can be used to establish the credentials (e.g. identity) of the bearer of the certificate. Digital certificates typically include the bearer's name, a serial number, expiration dates, a copy of the certificate holder's public key (used for encrypting messages and digital signatures), and the digital signature of the certificate-issuing authority so that a recipient can verify that the certificate itself is. Some digital certificates conform to the X509 standard Digital certificates can be kept in registries so that authenticating users can look up other users' public keys.

Common fields of digital certificates includes the serial number (used to uniquely identify the digital certificate) the subject (the bearer or entity that owns the digital certificate), the issuer (the entity that verified the information provided by the bearer of the certificate and issued the certificate itself), the expiration date of the certificate (the date after which the certificate is no longer valid), permitted key usage (the valid cryptographic uses of the bearer's public key), extended key usage (the applications in which the certificate can be used, for example, server authentication, email protection, and code signing), the public key (the public key belonging to the bearer of the certificate), the signature algorithm (the algorithm(s) used to perform hashes or signing), and the signature (the body of the certificate is hashed using the aforementioned signature algorithm and the hash is signed using the signature algorithm and the certificate issuer's private key).

Digital certificates have varying degrees of security, and can include class 1 digital certificates, class 2 digital certificates, and class 3 digital certificates. Class 1 digital certificates are based on little more than a valid email address, and involve no direct verification of the identity of the bearer. Class 2 digital certificates are verified against a trusted pre-verified database, and can be used to verify the bearer's identity. Class 3 digital certificates require that the bearer present themselves to a registration authority to prove their identity.

Digital certificates are issued by certificate authorities (CAs). Typically, CAs are third party entities that accept information from another entity requesting a certificate, and use that information to determine if the entity is in fact who they claim to be. If the entity has shown the entity is who they purport to be, the CA issues the digital certificate. Certificates may also be issued by CAs that are not third parties, or be issued by CAs that may not perform extensive verification of the identity of the requester before issuing the certificate. For example, a device may be sold to customers that includes digital certificates that are generated by the manufacturer, and in this case, the identity of the bearer of the certificate may simply be the serial number of the device.

As can be seen from the aforementioned issues, digital certificates may be from different entities that are commercially independent, and may be of different types and security levels. For example, a first set of digital certificates may be issued to any requestors by CA X (owned by Corporation X), and a second set of digital certificates may be issued to any requestors by CA Y (owned by a Corporation Y that is independent of and perhaps a competitor of Corporation X). Still a third set of digital certificates may be issued by CA Z, but only to devices manufactured by the same entity that manufactured the devices themselves. Still a fourth set of digital certificates may be issued by CA T, but only to devices that are using the services that are receiving the services provided by the same entity that controls CA T. Furthermore, CAs have different data, are generated with different algorithms, and are based on different levels of verification (as described in the class types above). This is particularly so in an Open RAN system. That means that the trustworthiness of a particular certificate may be hard to determine, with many being of dubious authenticity. Certificates may also become compromised.

For open and interoperable RAN systems to be readily deployable, the identity of the equipment needs to be secured to ensure the overall network's integrity. Challenges in this domain include the absence of a common trust chain, insufficient requirements on the certificate authority (CA) hierarchy and certificate profile, complexity in certificate management, and concerns regarding the legitimacy and credibility of Certificate Authorities (CAs).

The lack of standardized practices and the absence of a common trust chain across multiple vendors and network operators have led to difficulties regarding CA fragmentation, inconsistent security measures, and complexity.

### SUMMARY

To address the requirements described above, this document discloses a system and method for analyzing disparate certificates possibly issued by disparate sources within a disaggregated public key infrastructure. In one embodiment, the system comprises a database having a certificate repository and a certificate ingestion interface module, communicatively coupled to the certificate repository, the certificate ingestion interface module for ingesting certificates issued by the disparate sources. The system further comprises an analytics engine, communicatively coupled to the certificate repository, for analyzing attributes of the ingested certificates, a reporting engine, communicatively coupled to the certificate repository, for visualizing and reporting results of the analytics engine via a reporting interface, and an administrative interface, communicatively coupled to the certificate repository, for managing the system.

Another embodiment is evidenced by a method for analyzing disparate certificates issued by possibly disparate sources within a disaggregated public key infrastructure. In one embodiment, the method comprises ingesting a plurality of certificates in a certificate ingestion interface module, at least two of the plurality of certificates issued by the disparate sources, storing the ingested plurality of certificates in a certificate repository communicatively coupled to the certificate ingestion interface module, analyzing, using an analytics engine communicatively coupled to the certificate repository, attributes of the ingested certificates, and generating, using a reporting engine communicatively coupled to the analytics engine, a report having the analyzed attributes of the ingested certificates.

Still another embodiment is evidenced by a system having a processor and a communicatively coupled memory storing processor instructions for performing the foregoing operations.

The features, functions, and advantages that have been discussed can be achieved independently in various embodiments of the present invention or may be combined in yet other embodiments, further details of which can be seen with reference to the following description and drawings.

### BRIEF DESCRIPTION OF THE DRAWINGS

Referring now to the drawings in which like reference numbers represent corresponding parts throughout:

FIG. 1 is a diagram of one embodiment of the security assurance system;

FIG. 2 is a diagram illustrating exemplary operations used in operating the security assurance system;

FIG. 3 is a diagram presenting operations that perform further analysis of the ingested certificates; and

FIG. 4 is a diagram illustrating an exemplary computer system that could be used to implement processing elements of the security assurance system.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

As described above, the lack of standardized practices and the absence of a common trust chain across multiple vendors and network operators have led to difficulties that include CA fragmentation, inconsistent security measures, and complexity.

### CA Fragmentation

Each vendor may have its own implementation of a Certificate Authority (CA) that issues certificates with varying attributes, extensions, cryptographic algorithms, key sizes, etc. CA Fragmentation creates a situation where certificates and CA chains may not be universally recognized or accepted by devices made by various vendors. As a result, when different devices engage in the security handshake and exchange messages, validating these certificates becomes problematic, leading to the inability to establish secure communication channels. This problem poses interoperability challenges and acts as one of the several obstacles in transitioning from closed RAN to Open RAN, hindering seamless communication between devices.

### Inconsistent Security Measures

The lack of standardized requirements for CAs not only presents challenges in ensuring consistent security measures across Open RAN ecosystems but also has broader implications. This absence of standardization extends to the underlying cryptographic algorithms and key sizes employed to achieve confidentiality and authenticity of communication channels within the networks.

Varying CA/trust chain implementations with different operational practice may result in disparities in security levels, undermining the trustworthiness and authenticity of certificates. This can potentially lead to unauthorized access, impersonation attacks, or man-in-the-middle attacks. The use of different cryptographic algorithms and key sizes has significant ramifications on performance, bandwidth utilization, and device code footprint. Inconsistent choices in these areas impact the overall security posture, and introduce complexities and inefficiencies, hindering the seamless interoperability and optimal functioning of Open RAN deployments.

### Complexity

Without a common root of trust, the process of establishing and maintaining trust relationships becomes more resource-intensive and time-consuming. Each trust relationship needs to be established and validated individually which can create complexity and inefficiency in managing trust across various components and entities within Open RAN networks. Lack of a common root of trust results in increased costs throughout the lifecycle of the network, which can significantly inflate development, deployment, and maintenance expenses. These increased costs can pose challenges for network operators and vendors impacting the overall affordability and sustainability of Open RAN deployments.

The absence of standardized practices and the complex trust relationships represents significant challenges. See, for example: CISA (gov), “Open Radio Access Network Security Considerations,” 2022; 3GPP, “Security Architecture and Procedures for 5G System”, Technical Specification #33.501, Chapter 9, Certificate Enrollment for Base Stations, March 2023, which is hereby incorporated by reference herein. The O-RAN Alliance Security Working Group has also developed three key security-related documents published in March 2023, all of which are hereby incorporated by reference herein: “O-RAN Security Requirements Specifications”; “O-RAN Security Protocol Specifications”; “O-RAN Security Test Specifications.”

The testing specification list above covers very specific tests for certificates and may not cover the full spectrum of potential security problems. These tests lack a systematic approach, potentially leaving room for undiscovered issues. Additionally, there is currently no centralized repository available for gathering and analyzing all the certificates issued by various Certificate Authorities (CAs) provided by different vendors. This absence of a comprehensive certificate repository hinders the ability to perform in-depth analysis and gain insights into the overall security problems of Open RAN networks.

The lack of standardized requirements and trust among 5G vendors and operators has resulted in complex trust relationships, inconsistent security measures, and ad hoc practices, posing risks to network security, interoperability, and scalability.

### Overview

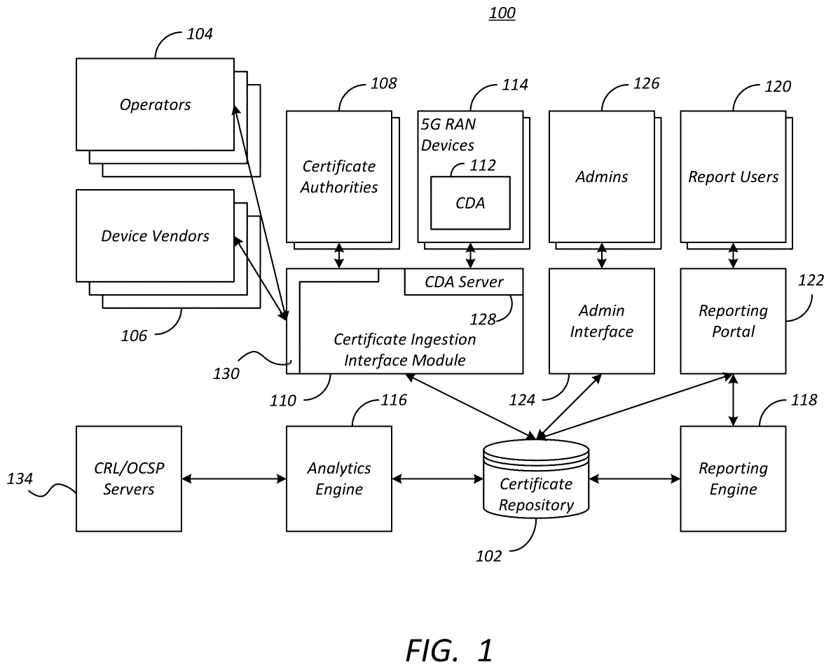

FIG. 1 is a diagram of one embodiment of the security assurance system (SAS) 100. The SAS 100 disclosed herein addresses critical security challenges in Open RAN networks, specifically focusing on the Public Key Infrastructure and digital certificates, which form the foundation for secure communications.

The SAS 100 provides a cloud-based open testing framework, SAF, which overcomes the limitations of vendor-specific testing methods, and serves as a platform for proactive testing, comprehensive analysis, and timely feedback, enabling the identification and mitigation of potential interoperability issues and security risks early in the development cycle of Open RAN systems. Using the SAS 100, the gaps between industry security practices are closed to enhance the trust for 5G Open RAN systems.

For open and interoperable RAN systems to be readily deployable, the identity of the equipment needs to be secured to ensure the overall network's integrity. The SAS 100 addresses the security challenges introduced by multi-vendor 5G Open RAN systems. The SAS 100 provides a comprehensive solution to identify and address security issues related to PKI and digital certificates, ensuring robust network security and trustworthiness. The SAS 100 serves as a platform for proactive testing, comprehensive analysis, and timely feedback, enabling the identification and mitigation of potential interoperability issues and security risks early in the development cycle. The SAS 100 can be used to bridge the gap between industry security practices and enhance the trust for 5G Open RAN systems.

Through collaboration, knowledge sharing, and the deployment of comprehensive testing methodologies within the SAS 100, a robust and reliable testing framework is established that benefits all stakeholders involved in the integration and deployment of PKI-based certificates in Open RAN networks. The SAS 100 not only improves network security but also promotes industry-wide adoption of standardized security practices, ensuring the deployment of secure and interoperable 5G networks. Furthermore, our methodologies and systems are applicable to non-5G networks as well.

The SAS 100 provides a robust cloud-based security assurance framework designed specifically to test and validate certificates issued by various certificate authorities operated by a diverse range of device vendors, operators, and industrial consortiums. The SAS 100 obtains certificates, validates the certificates and the trust chain, analyzes the certificates themselves, allows visualization of the certificate analysis, including certificate statuses, and generates reports. The SAS 100 may also send alerts to users. The SAS 100 encompasses the following key components:

Comprehensive Certificate Repository 102: The SAS 100 comprises a database that implements a certificate repository 102 that serves as a centralized resource for storing and managing certificate data, enabling efficient analysis and validation processes.

Analytics Engine 116: The SAS 100 also comprises an analytics engine 116, communicatively coupled to the certificate repository 102 and relevant Certificate Revocation List (CRL)/Online Certificate Status Protocol (OCSP) servers 134. The analytics engine 116 performs comprehensive attribute analysis of certificates, CAs 108, and devices 114. This is accomplished by using established standards, practices, and procedures as references for assessment, thus ensuring accurate and insightful results. The analytics engine 116 uses both parameter and AI-based data-driven methods in performing such analysis.

Reporting Engine 118: The SAS 100 also comprises a Reporting Engine 118, communicatively coupled to the certificate repository 102 and the analytics engine 116. The Reporting Engine 118 generates reports that provide monitoring capabilities for certificate usage, status, and alerts. These reports focus on key certificate status indicators that help identify security issues and facilitate effective certificate management. By providing such reports, the SAS 100 can contribute to establishing a common trust framework, further enhancing interoperability in the ecosystem, and providing certificate analysis results to report users 120, which may include operators, 104, device vendors 106, certificate authorities 108 and administrators 126, as well as any other parties that may have an interest in such reports.

The SAS 100 addresses existing gaps in security assurance by implementing a systematic approach to PKI/CA and certificate-related testing. The SAS 100 includes a cloud-based implementation in which any or all of the analytics engine 116, admin interface 124, reporting portal 122, analytics engine 116, certificate repository 102 and reporting engine 118 may be implemented in the cloud. As implemented, the SAS 100 provides a centralized repository for collecting certificates from various CAs 108, operators 104, and device vendors 106, including those obtained directly from devices 114. This framework conducts comprehensive tests, validations, and data analyses using the advanced analytics engine 116, specifically focusing on device certificates issued by different certificate authorities 108 operated by device vendors 106, operators 104, and industrial consortiums. By leveraging informative reporting mechanisms, the solution provides valuable insights and actionable intelligence to stakeholders involved in the Open RAN ecosystem, covering aspects such as security, interoperability, efficiency, affordability, and sustainability.

The SAS 100 examines and evaluates transport layer security (TLS) and Internet Protocol Security (IPSec) certificates across devices and vendors. Evaluations include:

Certificate Attribute Validation: The SAS 100 examines certificates to assure the correctness and validity of certificate/chain attributes, such as subject name, issuer name, expiration date, key usage/security strength, and extended key usage.

Trust Relationship Assessment: The SAS 100 evaluates the trust relationships established by certificate chains under different Certificate Authorities (CAs) 108 to validate the formation of a valid and trusted path from the end-entity certificate to a recognized and legitimate root CA 108.

Key Pair Strength Tests: The SAS 100 assesses the strength and security of the cryptographic key pair used in the certificate, including evaluations of key length, algorithm strength, and overall system security level.

CA Availability and Reliability Test: The SAS 100 examines the availability and reliability of the CAs 108 by analyzing factors such as the number of certificates issued, renewed, and revoked, and by checking the relevant CRL/OCSP servers 134 for certificate revocation CRL update rates, and responsiveness of online certificate status protocol (OCSP) check.

Statistical and Trend Test: The SAS 100 conducts statistical analysis to identify trends, patterns, and changes in certificate attributes, issuers, subjects, lifetimes, key sizes, certificate issuance rates, and cryptographic algorithm usage.

The testing methodology is based on the gathering and analysis of public information scattered throughout the network. This approach ensures the feasibility of collaboration and adoption by stakeholders, as it utilizes publicly available data to conduct thorough testing and evaluation without compromising sensitive information.

The SAS 100 addresses the practical needs of improving interoperability and overcoming roadblocks for the security and authenticity of 5G Open RAN networks. One significant limitation observed in the current landscape is the vendor/CA-specific nature of testing methodologies for certificates. In other words, devices with certificates issued under the same CA 108 can establish secure communications easily, while devices with certificates from different CAs 108 face challenges in effectively and efficiently establishing secure connections. This limitation stems from the lack of standardized implementation approaches and a common trust framework that universally recognizes and accepts certificates issued by various CAs 108.

To tackle this limitation, the SAS 100 uses a cloud-based security assurance framework. This framework enables all the stakeholders to conveniently access information about trusted CAs 108 and their certificates, facilitating seamless validation and eliminating the complexities associated with managing multiple trust relationships. By confidently recognizing and accepting certificates issued by any trusted CA 108 in the ecosystem, the framework promotes interoperability across the Open RAN ecosystem.

In addition, the SAS 100 includes duplicate key detection mechanisms, which identify instances of duplicate keys across multiple devices 114. The detection mechanisms alert to the presence of duplicated keys, indicating potential security compromises due to the lack of proper identification. Through in-depth analysis of device certificates, insight into device security and certificate management practices may be obtained. This ensures that the keys and certificates installed on devices 114 remain uncompromised and valid, enabling seamless and reliable connections with other devices in the network.

Furthermore, the SAS 100 generates informative reports on parameters such as certificate types, usage patterns, product attributes, and certificate issuance rates. These reports provide transparency and valuable business intelligence, highlighting potential security issues that could disrupt network operations and services if left unaddressed.

This SAS 100 also transcends the boundaries of Open RAN and 5G, extending their benefits to future generations of wireless networks. Through openness, collaboration, and standardization, it lays the groundwork for a robust and adaptable testing framework that addresses certificate-related challenges across evolving wireless ecosystems.

### Ingestion and Storage of Certificates in a Certificate Repository

The SAS 100 is cloud-based, and includes a certificate repository 102 which is used to aggregate large volumes of digital certificates from multiple and different sources, including multiple and different device operators 104, multiple and different device vendors 106, and multiple and different CAs 108.

The SDS 100 comprises a certificate ingestion interface (CII) 110 communicatively coupled to the certificate depository 102, the analytics engine 116, certificate authorities 108, operators 104, device vendors 106, and devices 114. The sources of the certificates and the certificates themselves may be disparate in character. That is, while the certificates may qualify as digital certificates, they may differ from one another in kind or in other diverse ways that make direct comparison of their attributes difficult. Often the disparate nature of the certificates is at least partially a product of the diversity of CAs 108 issuing the certificates, diversity of device 114 types and configurations, diversity of operator 104 or vendor 106 requirements.

Any or all of the sources of certificates, including operators 104, device vendors 106, certificate authorities 108, and devices 114 may be operated, owned or controlled by entities that are unrelated to one another and operate independently.

The certificate ingestion interface 110 ingests certificates from disparate sources including one or more disparate device vendors, one or more operators 104, one or more devices 114 and one or more CAs 108. In this context, “disparate” sources refers to sources that can be from different device vendors 106, different operators 104, devices 114, and different CAs 108, as well as device vendors 106, operators 104, devices 114, and CAs 108 that are owned, managed, or controlled by different entities that may in fact be commercial competitors in their respective markets. The CII 110 comprises a first interface for accepting certificates and certificate chains from the plurality of disparate sources.

In one embodiment, the CII 110 comprises an interface 130 for accepting certificates and certificate chains from a plurality of disparate certificate authorities, and a CDA server 128 that is used to accept certificates from the devices 114, particularly via the CDAs 112. The CDA server 128 may comprise at least one of a certificate management protocol (CMP) server and a hypertext transfer protocol secure (HTTPS) server. The CDA server 128, when comprising of an HTTPS server, establishes a two-way secure socket layer (SSL) connection with each remote device 114 using one or more certificates from that remote device 114, and upon successful two-way SSL connection accepts such certificates.

Certificates may be ingested from Open RAN devices 114 via a CDA server 128 when comprising of a Certificate Management Protocol (CMP) server using the CMPv2 protocol. For example, a CMPv2 server may be established, and the devices 114 may be configured to send a “genm” type message to the CMPv2 service carrying certificates that should be ingested. The CDA server 128 may support other protocols compatible with those supported by CDAs 112.

Once the certificates are obtained, a validation process is conducted to ensure the authenticity and integrity of the certificates. This involves verifying the certificates against trusted CAs 108 and validating the trust chains, ensuring that each certificate in the chain is valid and can be traced back to a trusted root certificate. For the completeness of evaluation, both valid and invalid certificates are ingested and saved in the certificate repository 102, allowing for comprehensive analysis and identification of potential vulnerabilities or anomalies in the certificate ecosystem. The certificate repository may also validate messages that are received from the devices 114 where the devices' private keys are used to create a signature over the messages.

### Analytics Engine

The SDS 100 further comprises an analytics engine 116. The analytics engine 116 is communicatively coupled to the certificate repository 102 analyzes the ingested certificates and stores the analysis results along with the ingested certificates in the certificate repository 102. Such analysis may include any or all of (1) analyzing certificate attributes and trust relations, (2) detecting key and certificate anomalies, (3) analyzing remote device attributes, and (4) deriving statistics and identifying trends in certificate issuance.

The analytics engine 116 performs certificate and key analysis, and also evaluates device attributes, trust relationships among certificates, and security parameters, including anomaly detection for key and certificate attributes, assessment of certificate trust relationships, statistical analysis, and trend analysis.

With regard to analyzing certificate attributes and trust relationships, the analytics engine 116 may:

Identify Most Common Certificate Issuers: The analytics engine 116 determines which CAs 108 or other sources of certificates issued the certificates most recently received and stored in the certificate repository 102. The analytics engine 116 evaluates the certificates in the certificate repository 102 to determine if there are any patterns or trends in the issuance of certificates by particular CAs 108 and determine whether the trustworthiness or reliability of particular CAs 108 can be determined based on the prevalence of certificates from those particular CAs 108 or patterns or trends in the issuance of certificates by those CAs 108. For example, if a particular CA 108 may have issued a much greater number of certificates than usual over the preceding few days. In this case, analytics engine 116 uses the data in the certificate repository, to identify this trend and bring it to the attention of report users 120 using the reporting portal 122 and the reporting engine 118. The CA 108 may be contacted to assure such issuances were intended and the certificates issued by this CA 108 may be made subject to additional testing to assure their validity.

Average Key Sizes and Algorithms Used: The analytics engine 116 determines the relevant statistics regarding the key sizes and algorithms used among the certificates (or subset of certificates) stored in the repository 102. This can be determined on a temporal basis (for example, key sizes from a particular CA 108 in the past few days are smaller than previously issued certificates). Using this information, weak keys and weak or outdated algorithms can be identified.

Key Usage Extension and/or Extended Key Usage Extension: The keys that form the basis for the certificates may be temporally extended so that they remain valid for an extended period of time. The analytics engine 116 may determine if a key extension is marked as critical or non-critical and whether the key extension is marked as required or recommended.

Certificate Validities: The analytics engine 116 determines other certificate statistics. For example, the analytics engine 116 may determine statistics regarding the duration for which certificates are valid (for example, the average and variance). The analytics engine 116 may also determine if there are significant variations in certificate lifetimes across different issuers (CAs) 108. The analytics engine 116 may also determine whether certificates being renewed in a timely manner or are there instances of prolonged validity. The analytics engine 116 may also determine any correlation between certificate lifetimes and the occurrence of security incidents. The analytics engine 116 may also identify any root, intermediate, or sub-CA certificates that will expire before the end-entity device certificate.

Revoked Certificates: The analytics engine 116 identifies revoked certificates and determine the reasons for the certificate revocations. Further, by analyzing certificate revocations and security incidents, the analytics engine 116 may determine and quantify correlation between security-related occurrences (e.g., identification of a security vulnerability or new malware) and revoked certificates. This information can be used to determine, for example, if other unrevoked certificates should be recommended to be revoked.

CA Trust Relationship and Hierarchy Information: The analytics engine 116 determines the hierarchical structure of the CAs 108 that issued the stored certificates. This allows identification of dominant CAs 108 (CAs 108 that issued more certificate or are along the line to the root of trust in a greater number of lineages), and also allows weak links or vulnerabilities in the CA hierarchy to be identified. Further, the overall trustworthiness and reliability of the certificate ecosystem can be assessed based upon the hierarchy analysis.

With regard to detecting key and certificate anomalies, the analytics engine 116 may examine the keys associated with the certificates. While TLS and IPsec private keys are not accessible to SAS 100, the corresponding public keys are included in the certificates, and may be the subject of analysis by the analytics engine 116. Through the analysis of these certificates and certificate contents, the security strength of PKI credentials utilized by devices is ascertained. For example, the SAS 100 may detect instances of duplicated keys or fixed keys. Devices with duplicated keys lack unique digital identities that would otherwise ensure their authenticity, and present potential vulnerabilities and security risks. Such risks can be identified by the analytics engine 116 and provided to the reporting engine 118 to provide this information to users 120 via the reporting portal 122. In another example, the analytics engine 116 is used to detect weak cryptographic keys generated by specific devices, device classes, or CAs 108. This can be accomplished by evaluating the key size and conducting rigorous arithmetic property validation of ECC public keys in accordance with NIST Special Publication 800-56A Revision (hereby incorporated by reference herein). Plausibility tests may also be performed including partial RSA public key validation, as defined in NIST Special Publication 800-89 (incorporated by references herein). Further, existing software/crypto security packages such as OpenSSL can be used to conduct additional weak key testing.

Evaluation of key security strength ensures that cryptographic implementations used by CAs 108 and by devices 114 meet stringent security standards. Moreover, device geolocation data could be collected from devices 114 and sent to the analytics engine 116 via the SAS 100, allowing detection of shared private keys among multiple devices from different geolocations. Cloned and impersonated devices 104, can be effectively identified, thereby mitigating potential breaches and unauthorized access associated with the use of the certificates from different device manufacturers.

These measures benefit both service provider/operators 104 such as Mobile Network Operators (MNOs) and device manufacturers. It not only assists MNOs in making informed decisions regarding device inclusion, but also helps device manufacturers enhance their security posture. This can prompt manufacturers to improve their manufacturing supply chain security and strengthen the protection of device keys. Accordingly, use of the SAS 100 can increase the overall security of Open RAN deployments while facilitating improvements throughout the device ecosystem.

With regard to analyzing device attributes, the analytics engine 116 may examine certain device attributes available in the certificates. Such device attributes include:

Device type and name.: Analysis of the device types and names of the certificates allow the analytics engine 116 to identify the most common device categories or types represented in the certificates. Such information may provide insight into specific product lines or categories as they relate to certificate security and may be used to identify discrepancies or inconsistencies in the device type or naming conventions. Such discrepancies may be used to identify potentially troubling devices 114 or device classes.

Device ID types (Serial Number (SN), IEEE MAC address, Full Qualified Domain Name (FQDN)): Analysis of device ID types can be used to identify predominant types of device identifiers in use. Variations or combinations of multiple identifier types can be identified, and it can be determined if specific CAs/organizations prefer certain identifier types over others.

Device ID and organization association (ex. MAC or FQDN vs. Organization): The analytics engine 116 determines how accurately do the device IDs align with their respective organizations. For example, if a particular device 114 issued by a specific organization typically uses a specified ID type, discrepancies between device IDs and their associated organizations can be identified and used as a basis for further investigation to identify potential security risks or misconfigurations.

Key Usage Extension and Extended Key Usage Extension: The analytics engine 116 identifies key (temporal) extensions, and identifies which of those key extensions were prevalent and for what purposes was the extension imposed. Significant variations in extensions across different device 114 types can be identified and an evaluation can be performed to determine whether identified extensions align with the intended purposes of the devices 114. Instances of key usage extensions that deviate from expected or recommended practices can be identified, as well as instances where devices 114 have key extensions that are unexpected or potentially risky. Product attributes that are often used in certificates for access control, policy enforcement, resource allocation, and device management. This testing and analysis in turn facilitate easier tracking, monitoring, and maintenance.

With regard to deriving statistics and identifying trends in certificate issuance, the analytics engine 116 also performs other statistical studies. For example:

Identifying Common Certificate Issuers: The analytics engine 116 may be used to identify the most frequently encountered CAs 108, and users of the SAS 100 organizations can assess the reputation and track records of the CAs 108.

Determining Average Key Sizes and Algorithms Used: By analyzing the above parameters, organizations can assess the overall security posture of their certificate-based systems.

The statistical analysis results provided by the analytics engine 116 enable user 120 to make informed decisions: identify potential vulnerabilities, mitigate security risks, ensure compliance, optimize certificate lifecycle management, and establish robust trust relationships within their certificate infrastructure.

Along with statistical analysis, the analytics engine 116 may also track changes in certificate issuance rates over time to identify sudden spikes or anomalies that may indicate potential security risks, such as unauthorized certificate issuance or compromised systems. The analytics engine 116 can also be used to monitor the growth of specific certificate types or key usages to optimize performance and resource allocation in areas experiencing significant growth, safeguarding network efficiency.

### Reporting Engine/Portal

The SDS 100 further comprises a reporting engine 118, communicatively coupled to the certificate repository 102, a reporting interface such as the reporting portal 122, for generating reports of the analysis performed by the analytics engine 116. The reporting engine 118 provides a web portal featuring searchable and sortable user interface tools for browsing the status of certificates based on desired search criteria. The reporting engine 118 provides convenient access to authorized individuals like government agencies, mobile service operators, device vendors) based on different access policies as determined by administrators.

The reporting engine 118 interfaces with the certificate repository 102 to generate reports of the analysis performed by the analytics engine 116. Such reports may include SAS 100 status information, certificate usage patterns and other information as described above. The results are available to users 120 via the reporting portal 122. An intuitive dashboard may be presented for efficient monitoring and management of the status of stored certificates, including, for example, listing all certificates associated with a particular device ID, and providing summary information on the number of active certificates, upcoming expirations, and revoked certificates.

This provides valuable information on certificate usage patterns, providing visibility into the security and compliance landscape and enabling proactive management. Additionally, the SDS 100 generates alerts for certificate expiration and revocation, ensuring timely actions can be taken to maintain a secure and reliable certificate infrastructure.

### Administrator Interface

The SDS further comprises an administrative interface 124, communicatively coupled to the certificate repository 102, for managing the SDS 100. The administrator interface 124 enables designated system administrators 126 to efficiently manage user 120 accounts and permissions for different information and statuses.

In addition, the admin interface 124 allows administrators to configure the system. Administrators 126 can also review system activity logs through the interface, enabling them to monitor and report user actions, system usages and changes, and other relevant activities. The administrator interface 124 also facilitates the execution of various system-wide tasks, such as initiating updates and configuring automated alerts or customer notifications.

### Certificate Discovery Agents

The SDS 100 also includes certificate discovery agents (CDAs) 112. CDAs 112 are software applications configured to run on the devices to discover certificates and provide them for ingestion. CDAs 112 can be provided to operators and vendors for installation on the devices via interface 130 or via a devoted CDA interface.

The CDAs 112 retrieve the certificates stored in the devices 114 and transmit the certificates (and optionally other device 114 information) to the SAS 100 (in one embodiment, via the certificate ingestion interface 110). In one embodiment, the CDAs 112 use one or more certificates on the devices 114 that can be used for secure socket layer (SSL) connections to establish a two-way SSL connection with the CDA server 128, and as a result send such certificates to the CDA server 128. In another embodiment, the CDAs 112 send the certificates on the devices 114 to the CDA server 128 using the CMPv2 protocol. The CDAs 112 may send the certificates on the devices 114 to the CDA server 128 using other protocols that both support. The CDAs 112 are typically installed on the devices 114 themselves and executed by the processor(s) of the devices 114, including, for example, secure processors of such devices 114. This ensures the correct provisioning of certificates for the intended devices 114 and enhances the overall security of the network. CDAs 112 operate with a wide range of RAN devices, including those running commonly used operating systems like Windows, Linux, Android, IOS, and vendor-specific platforms.

In one embodiment, the CDAs 112 are configured to support certificate renewal when required, enabling efficient management of certificates nearing expiration and reducing the risk of service disruptions. In further embodiments, the CDAs 112 gather other information regarding the devices 114 and their operation. Such data can include, for example, geolocation data. This geolocation information can be used to detect cloned or impersonated devices, and enhances device 114 tracking and monitoring capabilities, facilitating improved device management within the Open RAN network. The CDAs 122 may also be used to diagnose security-related device 114 issues and aid in identifying and addressing those issues. CDAs 112 can be provided that operate with all types and classes of devices 114, or CDAs 112 may be specifically designed for a particular type or class of device 114.

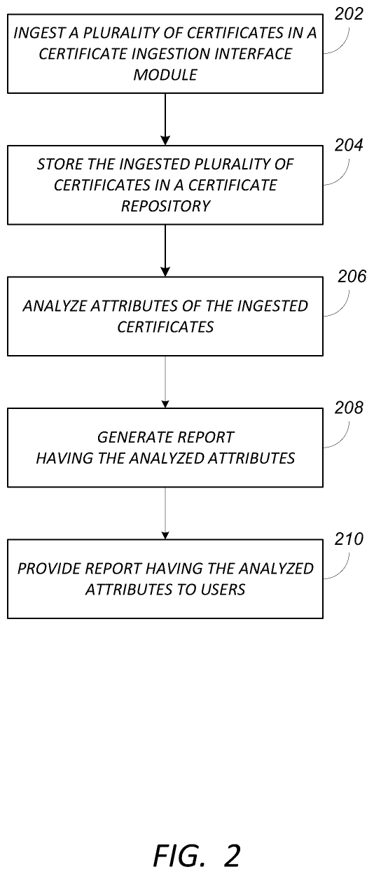

FIG. 2 is a diagram illustrating exemplary operations used in operating the SDS 100. In block 202, a plurality of certificates are ingested, for example by the CII module 110. This may be accomplished by ingesting certificates via a certificate authority interface 130 of the certificate ingestion module or by ingesting the certificate from the devices 114 via a CDA server 128, for example, via CDAs 112. For example, a two-way secure connection between the CDA server 128 and the remote devices 114 may be established at least in part using a certificate associated with each remote device 114. That process involves the devices 114 presenting a certificate to the server 128. This certificate is then ingested into the CII module 110.

Returning to FIG, 2, in block 204, the ingested plurality of certificates is stored in the certificate repository 102. In block 206, the attributes of the ingested certificates are analyzed, for example, by the analytics engine 116. Such analysis may include any one or more of analyzing trust relations, detecting key and certificate anomalies, analyzing attributes of the remote device(s) 114.

In block 208 a report is generated having the analysis of the attributes performed in block 206. In block 210, the report having the analyzed attributes is provided to users of the SAS 100.

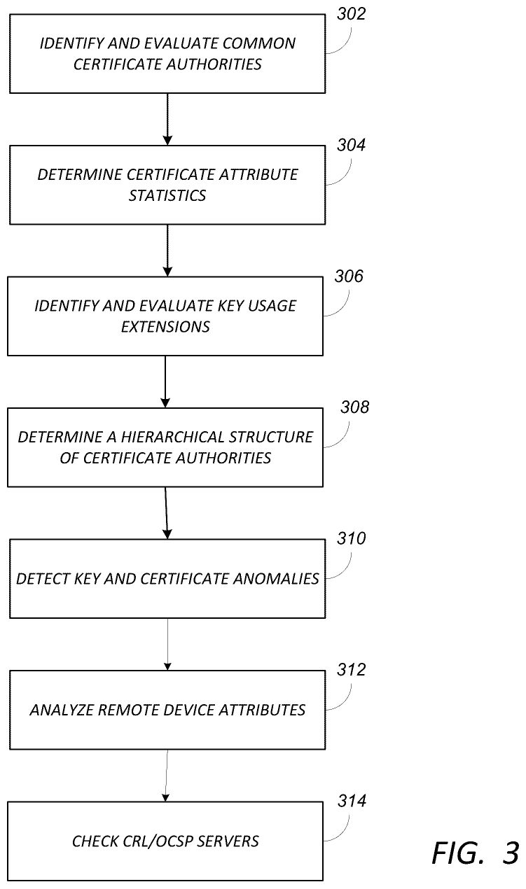

FIG. 3 is a diagram presenting operations that perform further analysis of the ingested certificates. This includes identifying and evaluating common certificate authorities 108, as shown in block 302. This identifies which of the CAs 108 are issuing certificates, so that the source of most certificates can be determined. Those that issue the most certificates can be the subject of further evaluation (e.g., evaluating the certificates from those CAs 108 in detail). Also, if a CA 108 goes from being a minor source of certificates to suddenly becoming a major source of certificates for different operators 104 or device vendors 106, that CA 108 may be investigated to determine why it is issuing so many more certificates than usual (e.g. are the certificates themselves phony or has the CA 108 been compromised).

The analysis may also include determining certificate attribute statistics, as shown in block 304. This information can be used to identify baseline characteristics so that notable variations from those baselines can be investigated for possible security breaches. Attributes include key size, algorithm, certificate duration, certificate revocation.

The analysis may also include identifying and evaluating key usage extensions, as shown in block 306.

The analysis may also include determining a hierarchical structure of the CAs as shown in block 308.

The analysis may also include detection and key and certificate anomalies, as shown in block 310. This may include the detection of fixed keys, the detection of duplicated keys, and the detection of weak keys. In one embodiment, the detection of duplicated keys may be assisted by the use of geolocation data from the devices 114 (for example determined from GPS, cell tower location, or IP address) and may take the key size into consideration. For example, if a key duplication (e.g. the public key of the certificate is identical to the public key of another certificate, the geolocation of the devices 114 having the certificates can be examined to determine whether the duplication of keys is likely do an authorized or unauthorized duplication (e.g. the same person using the same certificate on two different devices 114 or two different people using the same certificate with large public keys on two different devices). In cases where the key size is small, duplication at geographically diverse locations may be determined to be authorized. The size of the public keys may also be used to detect those certificates having cryptographically weak public keys.

The analysis may also include analyzing remote device attributes, including attribute statistics, as shown in block 312. Such attributes can be provided to the SDS 100 by the CDAs 112 of the devices 114 to the CII 110. Such attributes can include the identity and type of the devices 114, the memory size, processor type, and device event logs.

The analysis may also include contacting relevant CRL/OCSP servers, as shown in block 314.

### Hardware Environment

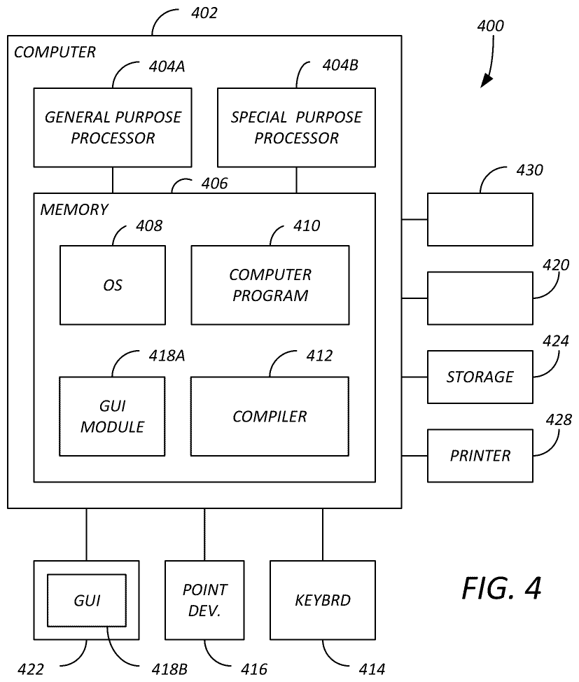

FIG. 4 illustrates an exemplary computer system 400 that could be used to implement processing elements of the above disclosure, including the any of the processors computing the processing threads. The computer 402 comprises a processor 404 and a memory, such as random access memory (RAM) 406. The computer 402 is operatively coupled to a display 422, which presents images such as windows to the user on a graphical user interface 418B. The computer 402 may be coupled to other devices, such as a keyboard 414, a mouse device 416, and a printer 428. Of course, those skilled in the art will recognize that any combination of the above components, or any number of different components, peripherals, and other devices, may be used with the computer 402.

Generally, the computer 402 operates under control of an operating system 408 stored in the memory 406, and interfaces with the user to accept inputs and commands and to present results through a graphical user interface (GUI) module 418A. Although the GUI module 418B is depicted as a separate module, the instructions performing the GUI functions can be resident or distributed in the operating system 408, the computer program 410, or implemented with special purpose memory and processors. The computer 402 also implements a compiler 412 which allows an application program 410 written in a programming language such as COBOL, C++, FORTRAN, or other language to be translated into processor 404 readable code. After completion, the application 410 accesses and manipulates data stored in the memory 406 of the computer 402 using the relationships and logic that was generated using the compiler 412. The computer 402 also optionally comprises an external communication device such as a modem, satellite link, Ethernet card, or other device for communicating with other computers.

In one embodiment, instructions implementing the operating system 408, the computer program 410, and the compiler 412 are tangibly embodied in a computer-readable medium, e.g., data storage device 420, which could include one or more fixed or removable data storage devices, such as a zip drive, floppy disc drive 424, hard drive, CD-ROM drive, tape drive, etc. Further, the operating system 408 and the computer program 410 are comprised of instructions which, when read and executed by the computer 402, cause computer 402 to perform the operations described herein. Computer program 410 and/or operating instructions may also be tangibly embodied in memory 406 and/or data communications devices 430, thereby making a computer program product or article of manufacture. As such, the terms “article of manufacture,” “program storage device” and “computer program product” as used herein are intended to encompass a computer program accessible from any computer readable device or media.

Those skilled in the art will recognize many modifications may be made to this configuration without departing from the scope of the present disclosure. For example, those skilled in the art will recognize that any combination of the above components, or any number of different components, peripherals, and other devices, may be used.

### Conclusion

This concludes the description of the preferred embodiments of the present disclosure.

The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

A system for analyzing disparate certificates within a public key infrastructure is disclosed. In one embodiment, the system comprises a database having a certificate repository; a certificate ingestion interface module, communicatively coupled to the certificate repository, the certificate ingestion interface module for ingesting certificates issued by the disparate sources; an analytics engine, communicatively coupled to the certificate repository, for analyzing attributes of the ingested certificates; a reporting engine, communicatively coupled to the certificate repository, for visualizing and reporting results of the analytics engine via a reporting interface; and an administrative interface, communicatively coupled to the certificate repository, for managing the system.

Implementations may include one or more of the following features.

Any of the above systems, wherein: the certificate ingestion interface module comprises a certificate authority interface for accepting certificates and certificate chains from a plurality of disparate certificate authorities; and a server for accepting certificates from remote devices.

Any of the above systems, wherein: analyzing attributes of the ingested certificate attributes comprises at least one of: analyzing trust relations; analyzing key and certificate anomalies; analyzing availability and responsiveness of the certificates' CRL and/or OCSP servers; analyzing remote device attributes; and analyzing trends in issuance rates of the ingested certificates, types of the ingested certificates, and cryptographic algorithms used by the ingested certificates.

Any of the above systems, wherein: the server comprises at least one of a certificate management protocol (CMP) server and a hypertext transfer protocol (HTTP) server.

Any of the above systems, wherein: the server ingests the digital certificates from the remote devices, the digital certificates provided from the remote devices to the server as a part of establishing a two-way secure connection between the server and the remote devices.

Any of the above systems, wherein: the analytics engine further validates the ingested certificates and certificate chains of the ingested certificates.

Any of the above systems, wherein: at least one of the remote devices comprises a certificate discovery agent executed by the remote device, the certificate discovery agent for retrieving a certificate stored on the remote device and providing the retrieved certificate to the certificate ingestion interface.

Any of the above systems, wherein: analyzing certificate attributes and trust relations, includes at least one of: identifying and evaluating common certificate authorities; and determining certificate attribute statistics, and the certificate attribute statistics including at least one of: key size statistics; algorithm statistics; certificate duration statistics; and certificate revocation statistics; identifying and evaluating key usage extensions; and determining a hierarchical structure of the certificate authorities. In this embodiment, the detection of key and certificate anomalies, includes at least one of: detection of fixed keys; detection of duplicated keys, wherein the duplicated keys are detected at least in part using remote device geolocation data; and detection of weak keys. This embodiment further comprises analyzing remove device attributes, including at least one of: generating remote device identity statistics; and generating remote device type statistics.

Another embodiment is evidenced by a method of analyzing disparate certificates within a public key infrastructure, comprising ingesting a plurality of certificates in a certificate ingestion interface module, at least two of the plurality of certificates issued by disparate sources; storing the ingested plurality of certificates in a certificate repository communicatively coupled to the certificate ingestion interface module; analyzing, using an analytics engine communicatively coupled to the certificate repository, attributes of the ingested certificates; and generating, using a reporting engine communicatively coupled to the analytics engine, a report having the analyzed attributes of the ingested certificates.

Implementations may include one or more of the following features.

Any of the above methods, wherein: ingesting the plurality of certificates comprises: ingesting a first set of certificates from a plurality of disparate certificate authorities via a certificate authority interface of the certificate ingestion module; and ingesting a second set of certificates from the remote devices via a server.

Any of the above methods, wherein: the remote devices each comprise a discovery agent executing on the device, each of the discovery agents accessing the certificates stored in the associated remote device and providing the accessed certificates to the certificate ingestion interface module.

Any of the above methods, wherein: ingesting the plurality of certificates comprises: establishing a two-way secure connection between the server and the remote devices, each two-way connection secured at least in part by a certificate associated with each remote device; and ingesting the certificate obtained from the establishment of the two-way connection between the server and the remote device.

Any of the above methods, wherein: analyzing attributes of the ingested certificates comprises at least one of: analyzing trust relations; detecting key and certificate anomalies; analyzing attributes of the remote device; and analyzing trends in issuance rates of the ingested certificates, types of the ingested certificates, and cryptographic algorithms used by the ingested certificates.

Any of the above methods, wherein: analyzing attribute of the ingested certificates comprises: identifying and evaluating common certificate authorities; determining certificate attribute statistics, the certificate attribute statistics including at least one of: key size statistics; algorithm statistics; certificate duration statistics; and certificate revocation statistics; identifying and evaluating key usage extensions; and determining a hierarchical structure of the certificate authorities; detection of key and certificate anomalies, and analyzing remove device attributes. The detection of key and certificate anomalies, include at least one of: detection of fixed keys; and detection of duplicated keys, wherein the duplicated keys are detected at least in part using remote device geolocation data; and detection of weak keys. The analyzing remove device attributes, includes at least one of: generating remote device identity statistics; and generating remote device type statistics.

Any of the above methods, wherein: the server comprises at least one of a certificate management protocol (CMP) server and a hypertext transfer protocol (HTTP) server.

Any of the above methods, wherein: the analytics engine further validates the ingested certificates and certificate chains of the ingested certificates.

Still another embodiment is evidenced by an apparatus having a processor and a memory communicatively coupled thereto that stores processor instructions comprising processor instructions for performing the foregoing methods.

What is claimed is:

1. A system for analyzing disparate certificates within a public key infrastructure, comprising:
a database having a certificate repository;
a certificate ingestion interface module, communicatively coupled to the certificate repository, the certificate ingestion interface module for ingesting certificates issued by the disparate sources;
an analytics engine, communicatively coupled to the certificate repository, for analyzing attributes of the ingested certificates;
a reporting engine, communicatively coupled to the certificate repository, for visualizing and reporting results of the analytics engine via a reporting interface; and
an administrative interface, communicatively coupled to the certificate repository, for managing the system.

2. The system of claim 1, wherein the certificate ingestion interface module comprises:
a certificate authority interface for accepting certificates and certificate chains from a plurality of disparate certificate authorities; and
a server for accepting certificates from remote devices.

3. The system of claim 2, wherein analyzing attributes of the ingested certificate attributes comprises at least one of:
analyzing trust relations;
analyzing key and certificate anomalies;
analyzing availability and responsiveness of the certificates' CRL and/or OCSP servers;
analyzing remote device attributes; and
analyzing trends in issuance rates of the ingested certificates, types of the ingested certificates, and cryptographic algorithms used by the ingested certificates.

4. The system of claim 3, wherein the server comprises at least one of a certificate management protocol (CMP) server and a hypertext transfer protocol (HTTP) server.

5. The system of claim 3, wherein: the server ingests the digital certificates from the remote devices, the digital certificates provided from the remote devices to the server as a part of establishing a two-way secure connection between the server and the remote devices.

6. The system of claim 3, wherein the analytics engine further validates the ingested certificates and certificate chains of the ingested certificates.

7. The system of claim 3, wherein at least one of the remote devices comprises a certificate discovery agent executed by the remote device, the certificate discovery agent for retrieving a certificate stored on the remote device and providing the retrieved certificate to the certificate ingestion interface.

8. The system of claim 1, wherein analyzing certificate attributes and trust relations, includes at least one of:
identifying and evaluating common certificate authorities;
determining certificate attribute statistics, the certificate attribute statistics including at least one of:
key size statistics;
algorithm statistics;
certificate duration statistics; and
certificate revocation statistics;
identifying and evaluating key usage extensions; and
determining a hierarchical structure of the certificate authorities;
detection of key and certificate anomalies, including at least one of:
detection of fixed keys;
detection of duplicated keys, wherein the duplicated keys are detected at least in part using remote device geolocation data; and
detection of weak keys;
analyzing remove device attributes, including at least one of:
generating remote device identity statistics; and
generating remote device type statistics.

9. A method of analyzing disparate certificates within a public key infrastructure, comprising:
ingesting a plurality of certificates in a certificate ingestion interface module, at least two of the plurality of certificates issued by disparate sources;
storing the ingested plurality of certificates in a certificate repository communicatively coupled to the certificate ingestion interface module;
analyzing, using an analytics engine communicatively coupled to the certificate repository, attributes of the ingested certificates; and
generating, using a reporting engine communicatively coupled to the analytics engine, a report having the analyzed attributes of the ingested certificates.

10. The method of claim 9, wherein ingesting the plurality of certificates comprises:
ingesting a first set of certificates from a plurality of disparate certificate authorities via a certificate authority interface of the certificate ingestion module; and
ingesting a second set of certificates from the remote devices via a server.

11. The method of claim 10, wherein the remote devices each comprise a discovery agent executing on the device, each of the discovery agents accessing the certificates stored in the associated remote device and providing the accessed certificates to the certificate ingestion interface module.

12. The method of claim 10, wherein ingesting the plurality of certificates comprises:
establishing a two-way secure connection between the server and the remote devices, each two-way connection secured at least in part by a certificate associated with each remote device; and
ingesting the certificate obtained from the establishment of the two-way connection between the server and the remote device.

13. The method of claim 10, wherein analyzing attributes of the ingested certificates comprises at least one of:
analyzing trust relations;
detecting key and certificate anomalies;
analyzing attributes of the remote device; and
analyzing trends in issuance rates of the ingested certificates, types of the ingested certificates, and cryptographic algorithms used by the ingested certificates.

14. The method of claim 10, wherein analyzing attribute of the ingested certificates comprises:
identifying and evaluating common certificate authorities;
determining certificate attribute statistics, the certificate attribute statistics including at least one of:
key size statistics;
algorithm statistics;
certificate duration statistics; and
certificate revocation statistics;
identifying and evaluating key usage extensions; and
determining a hierarchical structure of the certificate authorities;
detection of key and certificate anomalies, including at least one of:
detection of fixed keys;
detection of duplicated keys, wherein the duplicated keys are detected at least in part using remote device geolocation data; and
detection of weak keys;
analyzing remote device attributes, including at least one of:
generating remote device identity statistics; and
generating remote device type statistics.

15. The method of claim 10, wherein the server comprises at least one of a certificate management protocol (CMP) server and a hypertext transfer protocol (HTTP) server.

16. The method of claim 10, wherein the analytics engine further validates the ingested certificates and certificate chains of the ingested certificates.

17. An apparatus for analyzing disparate certificates within a public key infrastructure, comprising:
a processor;
a memory, communicatively coupled to the processor, the memory storing processor instructions comprising processor instructions for:
ingesting a plurality of certificates in a certificate ingestion interface module, at least two of the plurality of certificates issued by disparate sources;
storing the ingested plurality of certificates in a certificate repository communicatively coupled to the certificate ingestion interface module;
analyzing, using an analytics engine communicatively coupled to the certificate repository, attributes of the ingested certificates; and
generating, using a reporting engine communicatively coupled to the analytics engine, a report having the analyzed attributes of the ingested certificates.

18. The apparatus of claim 17, wherein the processor instructions for analyzing attributes of the ingested certificate attributes comprises processor instructions for at least one of:
analyzing trust relations;
detection of key and certificate anomalies;
analyzing remote device attributes; and
analyzing trends in issuance rates of the ingested certificates, types of the ingested certificates, and cryptographic algorithms used by the ingested certificates.

19. The apparatus of claim 17, wherein the processor instructions for analyzing attribute of the ingested certificates comprise instructions for:
identifying and evaluating common certificate authorities;
determining certificate attribute statistics, the certificate attribute statistics including at least one of:
key size statistics;
algorithm statistics;
certificate duration statistics; and
certificate revocation statistics;
identifying and evaluating key usage extensions; and
determining a hierarchical structure of the certificate authorities;
detection of key and certificate anomalies, including at least one of:
detection of fixed keys;
detection of duplicated keys, wherein the duplicated keys are detected at least in part using remote device geolocation data; and
detection of weak keys;
analyzing remove device attributes, including at least one of:
generating remote device identity statistics; and
generating remote device type statistics.

20. The apparatus of claim 17, wherein the processor instructions for ingesting a plurality of certificates in a certificate ingestion interface module comprises:
processor instructions for accepting at least one certificate from a discovery agent executing on an associated remote device.
